(19) United States
(12) Patent Application Publication
(10) Pub. No.: US 2018/0066580 A1
(43) Pub. Date: Mar. 8, 2018

(54) TURBINE WHEEL ARRANGEMENT FOR A TURBINE

(71) Applicant: Mahle International GmbH, Stuttgart (DE)

(72) Inventors: Oliver Fritz, Aichtal (DE); Rolf Mueller, Steinheim/Murr (DE); Thomas Riemay, Korb (DE); Hans C. Uibeleisen, Stuttgart (DE); Peter Wieske, Korntal-Muenchingen (DE)

(21) Appl. No.: 15/557,464

(22) PCT Filed: Mar. 2, 2016
(86) PCT No.: PCT/EP2016/054443

§ 371 Date: Sep. 11, 2017

(30) Foreign Application Priority Data
Mar. 12, 2015 (DE) 10 2015 204 506.4

(51) Int. Cl. F02C 6/18; F02C 7/36; H02K 49/10

(52) U.S. Cl. CPC F02C 6/18; F02C 7/36; H02K 49/102; F05D 2230/51; F05D 2260/4041; F05D 2230/52; F05D 2220/60; H02K 49/108

(57) ABSTRACT

A turbine arrangement for a turbine may include a turbine wheel and a magnetic coupling having a first rotor and a second rotor, each of which may be rotationally movable about a common axis of rotation defining an axial direction. The first rotor maybe connected to the turbine wheel in a rotationally fixed manner, and may be magnetically coupled with the second rotor in the axial direction. At least one of the first rotor and the second rotor may include a base part, at least one magnetic element, and a holder on an end face of the base part facing the other rotor and in which the magnetic element may be retained. The holder may be designed as a retaining collar projecting axially from the second base part to the other rotor, and into which the magnetic element may be inserted.

### CROSS-REFERENCE TO RELATED APPLICATIONS

This application claims priority to International Patent Application No. PCT/EP2016/054443, filed on Mar. 2, 2016, and German Patent Application DE 10 2015 204 506.4, filed on Mar. 12, 2015, the contents of both of which are incorporated herein by reference in their entireties.

### TECHNICAL FIELD

The invention relates to a turbine wheel arrangement for a turbine, in particular a waste heat recovery device.

### BACKGROUND

Typically, large amounts of waste heat arise when operating an internal combustion engine. On principle, it is possible and desirable to convert these amounts of waste heat into mechanical work by means of corresponding thermodynamic processes or to store them in a manner, which is suitable for mechanical work, respectively. Basically, it is possible for instance to evaporate a fluid, such as for example ethanol, coolant or water-ammonia by means of the waste heat of an exhaust gas system, and to use the steam generated in this way to operate a turbine or another expansion or turbo-machine. The turbine wheel of the turbine should thereby work in a fluidically hermetically insulated area in order to subsequently heat the fluid used for the operation without loss again and to be able to use it to drive the turbine wheel. For safety reasons, a hermetical seal may be required as well, for instance to avoid an escape of ethanol and an ignition of the ethanol associated therewith. In this context, there is the problem of drivingly connecting the turbine wheel to a device, which uses the work of the turbine or the like.

It is known from the prior art to use magnetic couplings, by means of which the torque, which is generated by the turbine wheel in a fluidically insulated area, can be transmitted from the insulated area in a contact-free manner. For this purpose, it is known to connect the turbine wheel of the turbine in a rotationally fixed manner to a first rotor, which is arranged in the fluidically insulated area. The second rotor, in contrast, is arranged outside the insulated area. The torque transmission between the two rotors occurs by magnetic coupling of the magnetic elements, which are provided on the two rotors. Such common magnetic couplings typically have an internal rotor and an external rotor, both of which can be rotatably adjusted about a common axial axis of rotation. The external rotor is thereby arranged radially outside of the internal rotor with respect to the axis of rotation. If the internal rotor is for example connected to the turbine wheel in a rotationally fixed manner, the magnetic coupling of the magnetic elements, which are typically arranged on the outer circumferential side of the internal rotor, to the magnetic elements, which are arranged on the inner circumferential side of the external rotor, takes place in the radial direction. Such a circumferential arrangement of the magnetic elements with respect to the two rotors, however, is associated with a significant space requirement. In addition, a partition wall, which needs to be arranged radially between internal and external rotor and which thus needs to be realized as circumferential wall, is typically required for the fluidic separation of the internal rotor comprising the turbine wheel from the external rotor. The structural realization of such a circumferential wall in the smallest possible space between internal and external rotor, however, is structurally very extensive.

### SUMMARY

It is thus an object of the invention at hand to create an improved embodiment of a turbine wheel arrangement, preferably for waste heat utilization devices, which is in particular characterized by a small space requirement.

This object is solved by means of the subject matter of the independent patent claims. Preferred embodiments are the subject matter of the dependent patent claims.

It is thus the basic idea of the invention to connect a first rotor of a magnetic coupling to a turbine wheel in a rotationally fixed manner and to magnetically couple it axially to the second rotor. The turbine wheel arrangement according to the invention can be realized in an extremely space-saving manner by means of such an axially extending magnetic coupling between the two rotors. This applies in particular for the need of space in the axial direction, which can be reduced significantly compared to common magnetic couplings comprising a radial coupling between an internal and an external rotor. This also provides for a simplified, rotatably adjustable support of the turbine wheel on a turbine housing of the turbine wheel arrangement. The axial force, which forms between the two rotors, can further be used for tensioning or prestressing, respectively, the supports. Finally, the technically extensive embodiment of the partition wall between the two rotors in the form of a circumferential wall, which is required in the case of magnetic couplings comprising a radial coupling, when used in waste heat utilization devices, can be forgone.

A turbine wheel arrangement according to the invention comprises a turbine wheel and a magnetic coupling, which has a first and a second rotor. The two rotors can each be rotatably adjusted about a common axis of rotation, which defines an axial direction. The first rotor is connected to the turbine wheel in a rotationally fixed manner. The first rotor is furthermore magnetically coupled axially to the second rotor.

In an advantageous further development of the invention, the first rotor has at least a first magnetic element. The second rotor has at least a second magnetic element. The first and second magnetic elements are thereby arranged on axial front sides, which face one another, of the two rotors. The two rotors can thus be be magnetically coupled to one another in a highly effective manner.

In an advantageous further development of the invention, the first rotor comprising the at least one first magnetic element can be molded integrally on the turbine wheel. In other words, the at least one first magnetic element is attached directly to the turbine wheel. Such a simplified structural setup of first rotor and turbine wheel is associated with significant cost advantages in the production of the turbine wheel arrangement. In the alternative, however, the first rotor can also be capable of being detachably fastened to the turbine wheel. This facilitates in particular the replacement of a defective rotor.

In a further preferred embodiment, the magnetic coupling comprises at least two first magnetic elements, preferably a plurality of first magnetic elements. They are arranged along the circumferential direction of the first rotor adjacent to one another. In the alternative or in addition, the magnetic coupling can comprise at least two second magnetic elements, preferably a plurality of second magnetic elements, which are then also arranged along the circumferential direction of the second rotor adjacent to one another. The number of the first and second magnetic elements can thus be determined in an application-specific manner, which proves to be advantageous, when the magnetic coupling is to be realized as magnetic gear.

Particularly advantageously, the at least one first magnetic element and/or the at least one second magnetic element can be embodied as permanent magnet, which has a magnetic polarization direction along the axial direction. Magnetic elements embodied in this way are available commercially in a cost-efficient manner and in large quantities, which has an advantageous effect on the production costs of the turbine wheel arrangement.

In a further preferred embodiment, the first rotor can have a first base part, which is connected to the turbine wheel in a rotationally fixed manner. On this base part, a first accommodation, in which the at least one first magnetic element is accommodated, is present on a front side, which faces the second rotor. Such an accommodation facilitates the assembly of the at least one first magnetic element. This applies in particular when a plurality of first magnetic elements is present. As an alternative or in addition to the first rotor, the second rotor can analogously also have a second base part, at which a second accommodation is present on a front side facing the first rotor. The at least one second magnetic element is accommodated in this second accommodation.

To accommodate the magnetic elements in a stable manner in the first accommodation, it proves to be advantageous, when the first accommodation is embodied as a first accommodation collar, which projects axially away from the first base part towards the second rotor. The at least one first magnetic element is inserted into this first accommodation collar. As an alternative or in addition, the second accommodation can also be embodied as a second accommodation collar, which projects away from the second base part towards the first rotor. The at least one second magnetic element is inserted into the second accommodation.

For the improved reinforcement of the first accommodation, it is proposed in a further preferred embodiment to arrange a first outer sleeve element, which encloses the first accommodation collar along the circumferential direction, on the first accommodation collar radially on the outside. A fiber reinforced material, in particular carbon, which is characterized by a low dead weight while simultaneously having an extremely high mechanical stability, is thereby recommended as sleeve material of the first outer sleeve element. In the alternative or in addition, a second outer sleeve element, which encloses the second accommodation collar along the circumferential direction, can also be arranged on the second accommodation collar radially on the outside for the improved reinforcement of the second accommodation. A fiber reinforced material, in particular the carbon, which has already been mentioned, is also recommended for the sleeve material of the second outer sleeve element.

An improved reinforcement of the first accommodation can also be attained according to a further preferred embodiment, in the case of which a first inner sleeve element, which extends along the circumferential direction and which abuts against the first magnetic elements, is arranged radially on the inside on the first magnetic elements. The sleeve material of the first inner sleeve element can also comprise a fiber reinforced material, in particular carbon. In the alternative or in addition, a second inner sleeve element, which extends along the circumferential direction and which abuts against the second magnetic elements and the sleeve material of which comprises a fiber reinforced material, in particular carbon, can also be arranged on the second magnetic elements radially on the inside for the improved reinforcement of the second accommodation.

For application-specific reasons, it may be advantageous in the practice operation of the turbine wheel arrangement, when the speed of the turbine wheel is translated to slow. For this purpose, it is proposed to embody the magnetic coupling as magnetic gear, in particular in the manner of a reluctance gear.

If the magnetic coupling is to have the effect of a magnetic gear, it is proposed according to an advantageous further development of the invention to arrange a plurality of polar bars at the partition wall along the circumferential direction. These polar bars, together with the first and second magnetic elements, effect the desired translation of the speed of the turbine wheel to slow, when they are provided in adequate number.

In order to fluidically insulate the turbine wheel comprising the first rotor, in particular in response to use in a waste heat utilization device from the second rotor of the magnetic coupling, it is proposed in a particularly advantageous manner to provide a partition wall in the axial direction between the first and the second rotor. For instance, such a partition wall may be embodied in a space, which is arranged axially between the two rotors and which is preferably realized in the manner of a gap.

A particularly space-saving arrangement of the magnetic coupling is attained in an advantageous further development of the invention, in the case of which the partition wall runs perpendicular to the axis of rotation in a plane.

A particularly good magnetic coupling between the magnetic elements of the first and second rotor is attained when a gap width, which is defined by the axial distance between the two base parts, is maximally 3 mm, preferably maximally 1 mm.

Particularly preferably, the following components of the two rotors may be embodied as identical parts: the magnetic elements, the inner sleeve elements, and/or the outer sleeve elements. In this case, the mentioned components can be installed either into the first or second rotor of the turbine wheel arrangement. This leads to a simplified production of the turbine wheel arrangement and thus to reduced production costs of the turbine wheel arrangement according to the invention.

In a preferred embodiment, the first and second rotor are embodied as identical parts and can each be detachably fastened or are detachably fastened to the turbine wheel by means of a fastening bolt or by means of a screw connection or by press-fitting or by means of the outer sleeve element. The identical part can thus be fastened to the first or to the second rotor.

In an additional aspect of the invention, a turbine wheel arrangement for a turbine, in particular a waste heat utilization device, comprises a turbine wheel comprising a rotor, which is connected to the turbine wheel in a rotationally fixed manner. Together with the turbine wheel, the rotor can be rotatably adjusted about an axis of rotation, which defines an axial direction. The turbine wheel arrangement furthermore comprises a stator, which has at least two electrical coil elements on a front side, which axially faces the rotor. Finally, the turbine wheel arrangement comprises at least two first magnetic elements, which are arranged on the rotor on a front side thereof, which faces the stator. The magnetic elements are arranged in such a way that an electrical induction voltage is induced in the at least two electrical coil elements during a rotational movement of the rotor relative to the stator. The turbine wheel arrangement can thus be used as electrical generator. Such a turbine wheel arrangement comprising an axial coupling of magnetic elements and coil elements instead of a magnetic coupling has its own invention character. All of the above-mentioned advantages or advantageous embodiments, respectively, with respect to the use of an axially oriented magnetic coupling can also be transferred to such a turbine wheel arrangement, which acts as generator. The axial coupling of the magnetic elements of the rotor to the coil elements of the stator, which is attached to a turbine housing in a stationary manner, for example, on which the rotor is rotatably supported, ensures an arrangement with particularly small space requirements.

In a further alternative, the coil elements can be energized actively with electrical alternating current with the help of a suitable electrical alternating current source. In this scenario, the generated magnetic alternating field effects a rotational movement of the rotor about its axis of rotation by interaction with the magnetic elements of the rotor. In this case, the turbine wheel arrangement according to the additional aspect of the invention follows the operating principle of an electric motor.

The invention also relates to a turbine comprising a turbine housing and an above-presented turbine wheel arrangement, wherein the turbine wheel is rotatably supported on the turbine housing of the turbine.

Further important features and advantages of the invention follow from the subclaims, from the drawings and from the corresponding figure description by means of the drawings.

It goes without saying that the above-mentioned features and the features, which will be discussed below, cannot only be used in the respectively specified combination, but also in other combinations or alone, without leaving the scope of the invention at hand.

Preferred exemplary embodiments of the invention are illustrated in the drawings and will be discussed in more detail in the description below, whereby the same reference numerals refer to the same or to similar or functionally identical components.

### BRIEF DESCRIPTION OF THE DRAWINGS

In each case schematically

FIG. 1 shows a turbine wheel arrangement according to the invention in a longitudinal section along the axis of rotation of its rotors,

FIG. 2 shows the first rotor of the magnetic coupling of the turbine wheel arrangement in a front side top view,

FIG. 3 shows the second rotor of the magnetic coupling of the turbine wheel arrangement in a perspective illustration,

FIGS. 4-7 show an alternative of the turbine wheel arrangement of FIG. 1, in the case of which the magnetic coupling is embodied as magnetic gear,

FIG. 8 shows an alternative of the first and second magnetic elements of the magnetic coupling,

FIG. 9 shows an advanced alternative of the first rotor of FIGS. 1 to 7,

FIG. 9 shows a turbine wheel arrangement according to the invention according to the additional aspect of the invention.

### DETAILED DESCRIPTION

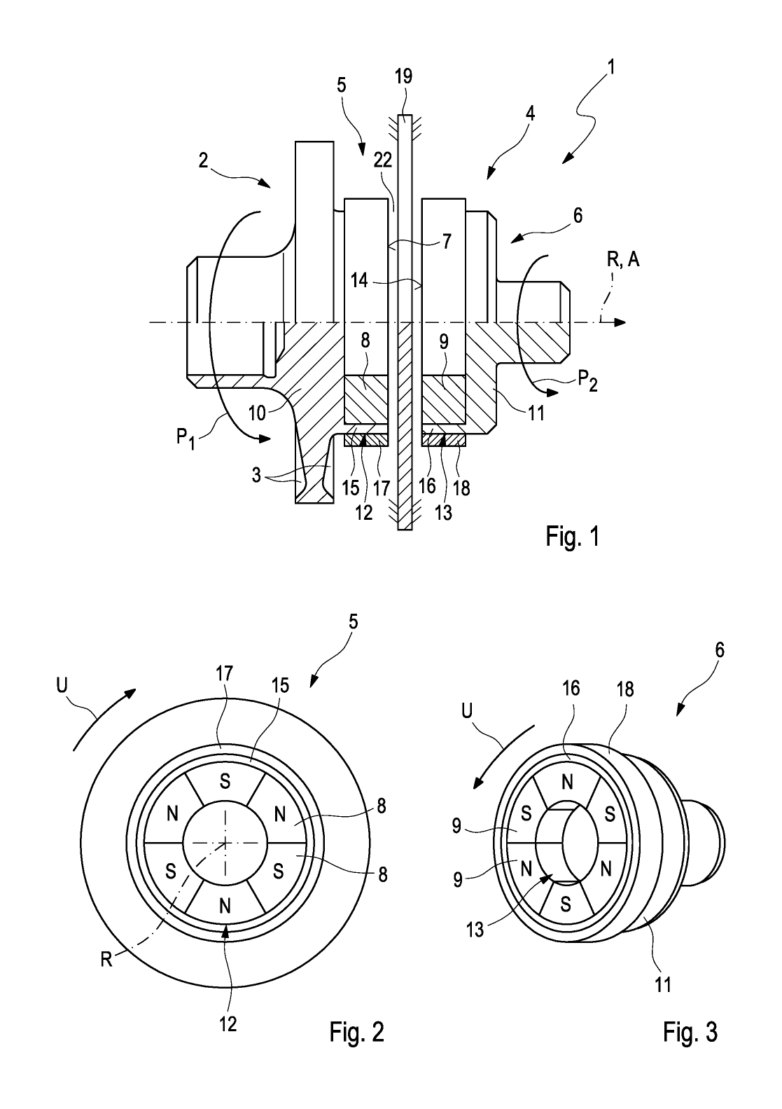

FIG. 1 shows an example of a turbine wheel arrangement 1 according to the invention. The turbine wheel arrangement 1 comprises a turbine wheel 2 comprising a plurality of rotor blades 3. The turbine wheel arrangement 1 furthermore has a magnetic coupling 4, which has a first and a second rotor 5, 6, which are in each case rotatably adjustable independently from one another about a common axis of rotation R, which defines an axial direction A. In FIG. 1, the rotational adjustability of the rotors 5, 6 is suggested by means of the arrows P₁, P₂. The first rotor 5 is connected to the turbine wheel 2 in a rotationally fixed manner, i.e. the turbine wheel 2 can also be rotatably adjusted about the axis of rotation R relative to the second rotor 6. According to the invention, the first rotor 5 is magnetically coupled axially to the second rotor 6. For this purpose, the first rotor 5 has a plurality of first magnetic elements 8, which are arranged adjacent to one another along the circumferential direction U of the first rotor 5. This scenario illustrates the illustration of FIG. 2, which shows the first rotor 5 in top view along the axial direction A towards a front side 7, which faces the second rotor 6. Analogously, the second rotor 6 has a plurality of second magnetic elements 9—shown in perspective illustration in FIG. 3—which are arranged adjacent to one another along the circumferential direction U of the second rotor 6. In an alternative of the exemplary embodiment, the first rotor 5 comprising the first magnetic elements 8 can be molded integrally on the turbine wheel 2. In the alternative, the first rotor 5 can also be embodied as separate component, which can be detachably fastened to the turbine wheel 2, in particular by means of a screw connection, by press-fitting or by means of a fastening bolt. This proves to in particular be advantageous, when the first and second rotor 5, 6 are embodied as identical parts.

The first magnetic elements 8 and the second magnetic elements 9 are each embodied as permanent magnets, which have a magnetic polarization direction along the axial direction. According to FIGS. 2 and 3, two first or second magnetic elements 8, 9 in each case have an opposite polarization in the circumferential direction U, i.e. in the top view of FIG. 2, a north pole N and a south pole alternate in the circumferential direction U. The same applies for the second magnetic elements 9 of the second rotor 6 (see FIG. 3).

When now looking at FIG. 1 again, it can be seen that the first rotor 5 has a first base part 10, which is preferably molded integrally on the turbine wheel 2. A first accommodation 12, in which the first magnetic elements 8 are accommodated, is present on the first base part 10 on the front side 7, which faces the second rotor 6. Accordingly, the second rotor 9 has a second base part 11, on which a second accommodation 13 is present on a front side 14, which faces the first rotor 6. The second magnetic elements 9 are accommodated in the second accommodation 13.

As shown clearly in FIGS. 1 to 3, the first accommodation 12 is embodied as a first accommodation collar 15, which projects axially from the first base part 10 towards the second rotor 6. The first magnetic element 8 are inserted into the first accommodation collar 15 (see FIG. 2). The second accommodation 13 (see FIG. 3) is also embodied as a second accommodation collar 16, which protrudes axially from the second base part 11 towards the first rotor 5. Analogously to the first accommodation collar 15, the second magnetic elements 9 are thus inserted into the second accommodation collar 16.

To reinforce the structure, a first outer sleeve element 17, which encloses the first accommodation collar 15 along the circumferential direction U, is arranged on the first accommodation collar 15 radially on the outside. The sleeve material of the first outer sleeve element 17 can comprise a fiber reinforced material, in particular carbon, or can consist thereof. To reinforce the structure, a second outer sleeve element 18, which encloses the second accommodation collar 16 along the circumferential direction U, is also arranged on the second accommodation collar 16 radially on the outside. The sleeve material of the second outer sleeve element 18 can also comprise a fiber reinforced material, in particular carbon, or can consist thereof. In particular, the following components of the two rotors 5, 6 can be embodied as identical parts: the base parts 10, 11, the magnetic elements 8, 9, the inner sleeve elements 23, and/or the outer sleeve elements 17, 18. These components can then either be installed into the first or second rotor 5, 6 of the turbine wheel arrangement 1. This results in significant cost savings in response to the production of the turbine wheel arrangement 1.

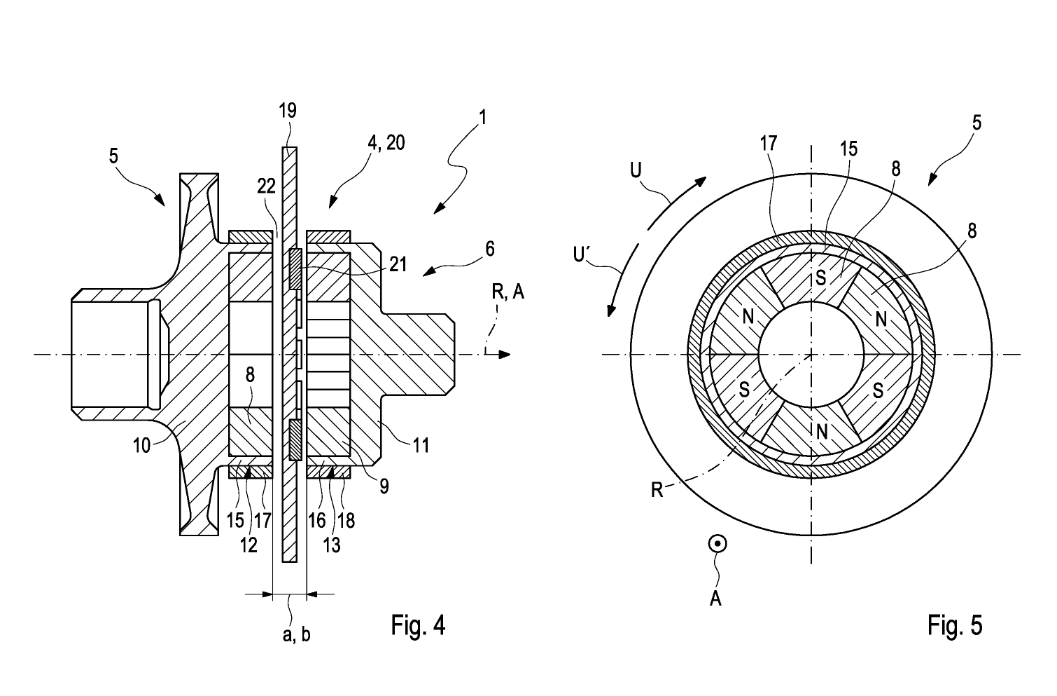

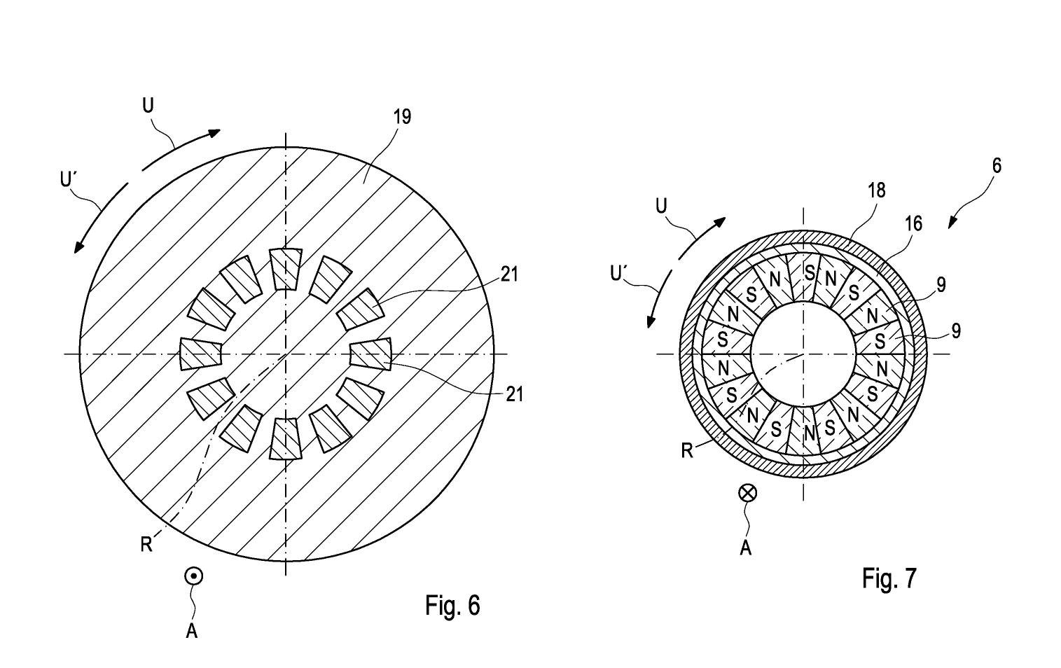

FIGS. 4 to 7 show an example of use of the turbine wheel arrangement 1, in the case of which the magnetic coupling 4 is realized as magnetic gear 20, which transfers the speed of the turbine wheel 2 to slow. The magnetic gear 20 can in particular be embodied in the manner of a reluctance gear. For this purpose, a partition wall 19, which runs in a plane perpendicular to the axis of rotation R, is arranged in the axial direction A in a gap 22 embodied there between the first and the second rotor 5, 6. In FIG. 6, the partition wall 19 is shown in separate illustration in a cross section perpendicular to the axial direction A. The axial distance a between the two base parts 10, 11 defines a gap width b, which is maximally 3 mm, preferably maximally 1 mm, to ensure a good magnetic coupling between the first and second magnetic elements 8, 9.

As shown in FIGS. 4 and 6, a plurality of polar bars 21 is arranged on the partition wall 19 along the circumferential direction U of the rotors 5, 6. In the example of FIG. 4, the number n of polar bars 21 is n=12. FIG. 5 shows the first magnetic elements 8 of the first rotor 5 in a cross section perpendicular to the axial direction A. It can be seen that six first magnetic elements 8 are present, which form three first pole pairs. The number of the first pole pairs will subsequently be identified as p₁, i.e. in the example of FIG. 5, p₁=3. FIG. 7 shows the second magnetic elements 9 of the second rotor 6 in a cross section perpendicular to the axial direction A. It can be seen that eighteen second magnetic elements 9 are present, which form nine second pole pairs. The number of the second pole pairs will subsequently be identified with p₂, i.e. in the example of FIG. 7, p₂=9. For the number of the polar bars n and the number of the first and second pole pairs p1, p2, the relationship

n=p₁+p₂

thus applies.

If the first rotor 5 comprising the first magnetic elements 8 is now rotated in the circumferential direction U, the magnetic fields generated by first magnetic elements 8 are permeated by the polar bars 21 on the stationary partition wall 19, resulting in that second rotor 6 and accordingly the second base part 11 comprising the second magnetic elements 9 rotates opposite to the circumferential direction U—identified with U′ in FIGS. 5 to 7. The speed of the first rotor 5 is thereby translated to slow according to the ratio p₁:p₂.

In a further example of use, which is not illustrated in detail in the figures, the second rotor 6 of the magnetic coupling 4 can be connected to the input shaft of a gear, in particular of a planetary gear, for translating the speed of the first rotor 5 to slow or, in the case of a suitable configuration, also to fast. The turbine wheel arrangement 1 according to the invention, which is presented herein, thus opens up a plurality of areas of application for the person of skill in the art.

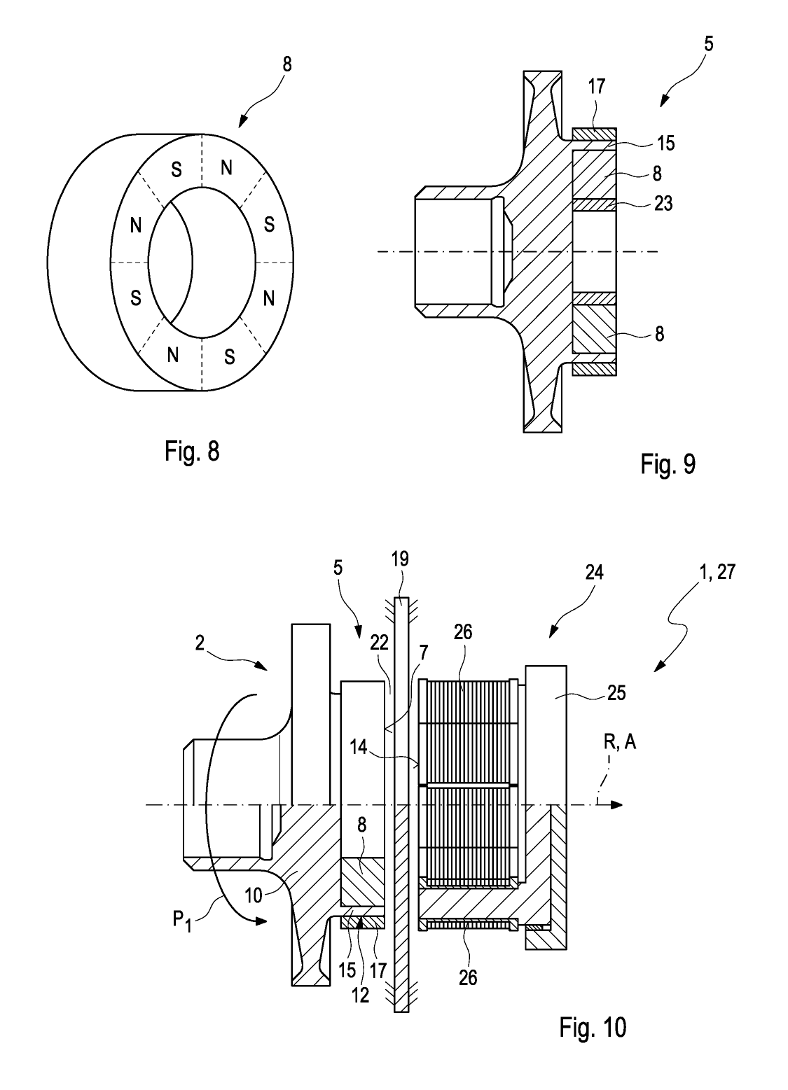

FIG. 8 shows an alternative of the first and second magnetic elements 8, 9. The example of FIG. 8 shows a first magnetic element 8, which is embodied in one piece and preferably in an annular manner. It can replace the individual first magnetic elements 8 of FIG. 1, in that the opposite axial polarization directions are integrated directly into the integral magnetic element 8. In other words, only a single first magnetic element 8 is installed in the first rotor 5 in this case. The extensive application of a plurality of first magnetic elements 8 can be forgone in this case. The example of a single and integral, preferably annular first magnetic element 8 instead of a plurality of first magnetic elements 8 can be transferred directly to the second magnetic elements 9, i.e. preceding explanations apply mutatis mutandis for a single and integral, preferably annular second magnetic element 9.

FIG. 9 shows an advanced alternative of the first rotor 5 of FIGS. 1 to 7. In the case of the first rotor 5 of FIG. 9, a first inner sleeve element 23, which extends along the circumferential direction U and which abuts against the first magnetic elements 9, is arranged radially on the inside on the first magnetic elements 9. With regard to a radial direction, the first accommodation collar 15 and the magnetic elements 8 are thus arranged in a sandwich-like manner between the inner and the outer first sleeve element 17, 23. A particularly good reinforcement of the first accommodation collar 15 can thus be attained. The sleeve material of the first inner sleeve element 23 can also comprise a fiber reinforced material, in particular carbon. The second magnetic elements 9 can also be equipped with such a second inner sleeve element (not shown explicitly in FIG. 9), wherein the above explanations relating to the first inner sleeve element 23 apply mutatis mutandis for the second inner sleeve element 23. In a preferred alternative of the example, the first and second rotor 5, 6 can be embodied as identical parts. The respective identical part can then be detachably fastened to the turbine wheel 2 by means of a fastening bolt or by means of a screw connection or by means of press-fitting or by means of the outer sleeve element 17, 18.

FIG. 10 shows an example of a turbine wheel arrangement 1 according to the invention according to the additional aspect. The arrangement of FIG. 10 differs from that of FIG. 1 in that the arrangement has only a (first) rotor 5. In contrast, a stator 24, which cannot be rotatably adjusted about the axis of rotation R of the rotor 5, but which is attached to a turbine housing 25 of the turbine wheel arrangement in a stationary manner, is present instead of the second rotor 6 of FIG. 1. The rotor 5 comprising the turbine wheel 2 is supported on this turbine housing 25 in a rotatably adjustable manner. As can be seen in FIG. 10, a further difference of the turbine wheel arrangement of FIG. 10 as compared to that of FIG. 1 is further that the stator 24 has at least two electrical coil elements 26 on a front side 14, which axially faces the rotor 5. Analogously to the arrangement of FIG. 1, a plurality of (first) magnetic elements 8 are arranged on a front side 7 of the rotor 5, which faces the stator 24. The magnetic elements 8 and the coil elements 26 are arranged in such a way that an electrical induction voltage is induced in the at least two electrical coil elements 26 during a rotational movement of the rotor 5 relative to the stator 24. The turbine wheel arrangement 1 can thus be used as electrical generator 27. In a further alternative, the coil elements 26 can be actively energized with an electrical alternating current with the help of a suitable electrical alternating current source (not shown). By means of interaction with the magnetic elements of the rotor 5, the generated magnetic alternating field effects a rotational movement of the rotor, i.e. the turbine wheel arrangement according to the additional aspect of the invention follows the operating principle of an electric motor in this case.

1. A turbine arrangement for a turbine, comprising:
a turbine wheel;
a magnetic coupling having a first rotor and a second rotor, each of which is rotationally movable about a common axis of rotation defining an axial direction;
wherein the first rotor is connected to the turbine wheel in a rotationally fixed manner;
wherein the first rotor is magnetically coupled with the second rotor in the axial direction;
wherein at least one of:
the first rotor includes a first base part connected to the turbine wheel in a rotationally fixed manner, at least one first magnetic element, and a first holder on an end face of the first base part facing the second rotor and in which the at least one first magnetic element is retained; and
the second rotor includes a second base part, at least one second magnetic element, and a second holder on an end face of the second base part facing the first rotor and in which at least one second magnet element is retained;
wherein the first holder is designed as a first retaining collar projecting axially from the first base part to the second rotor and into which the at least one first magnetic element is inserted; and
wherein the second holder is designed as a second retaining collar projecting axially from the second base part to the first rotor and into which the at least one second magnetic element is inserted.

2. A turbine wheel arrangement according to claim 1, wherein the at least one first magnetic element and the at least one second magnetic element are arranged on axial end faces of the first rotor and the second rotor, respectively, that face each other.

3. A turbine wheel arrangement according to claim 1, wherein the first rotor is one of formed integrally with the at least one first magnetic element on the turbine wheel or is detachably fixed to the turbine wheel.

4. A turbine wheel arrangement according to claim 1, wherein at least one of:
the at least one first magnetic element includes at least two first magnetic elements arranged adjacent to one another along a circumferential direction of the first rotor; and
the at least one second magnetic element includes at least two second magnetic elements arranged adjacent to one another along a circumferential direction of the second rotor.

5. A turbine wheel arrangement according to claim 1, wherein at least one of the at least one first magnetic element and the at least one second magnetic element is designed as a permanent magnet having a magnetic polarization direction along the axial direction.

6. A turbine wheel arrangement according claim 1, wherein:
on the first retaining collar, a first outer sleeve element is arranged radially outside, surrounding the first retaining collar along a circumferential direction, a material of the first outer sleeve element including a fibre composite material; and
on the second retaining collar, a second outer sleeve element is arranged radially outside, surrounding the second retaining collar along the circumferential direction, a material of the second outer sleeve element including a fibre composite material.

7. A turbine wheel arrangement according to claim 1, wherein:
a first inner sleeve element extending along a circumferential direction and resting on the at least one first magnetic element is arranged radially on the at least one first magnetic element, a material of the first inner sleeve element including a fibre composite material; and
a second inner sleeve element extending along the circumferential direction and resting on the at least one second magnetic element is arranged radially on the at least one second magnetic element, a material of the second inner sleeve including a fibre composite material.

8. A turbine wheel arrangement according to claim 1, wherein the magnetic coupling is designed as a magnetic transmission, which translates a rotation speed of the turbine wheel to a slower speed.

9. A turbine wheel arrangement according to claim 1, wherein a partition is arranged in the axial direction between the first rotor and the second rotor.

10. A turbine wheel arrangement according to claim 9, wherein the partition runs in a plane perpendicular to the axis of rotation.

11. A turbine wheel arrangement according to claim 9, further comprising a plurality of pole rods arranged on the partition along a circumferential direction.

12. A turbine wheel arrangement according to claim 11, wherein a gap width defined by an axial distance between the first base part and the second base part is no more than 3 mm.

13. A turbine wheel arrangement according to claim 1, wherein the at least one first magnetic element and the at least one second magnetic element are designed as identical parts.

14. A turbine wheel arrangement according to claim 1, wherein the first rotor and the second rotor are designed as identical parts and are detachably fixed to the turbine wheel by one of a mounting bolt, a screw connection, or crimping.

15. A turbine comprising:
a turbine housing; and
a turbine arrangement including:
a turbine wheel;
a magnetic coupling having a first rotor and a second rotor, each of which is rotationally movable about a common axis of rotation defining an axial direction;
wherein the first rotor is connected to the turbine wheel in a rotationally fixed manner;
wherein the first rotor is magnetically coupled with the second rotor in the axial direction;
wherein at least one of:
the first rotor includes a first base part connected to the turbine wheel in a rotationally fixed manner, at least one first magnetic element, and a first holder on an end face of the first base part facing the second rotor and in which the at least one first magnetic element is retained; and
the second rotor includes a second base part, at least one second magnetic element, and a second holder on an end face of the second base part facing the first rotor and in which at least one second magnet element is retained;
wherein the first holder is designed as a first retaining collar projecting axially from the first base part to the second rotor and into which the at least one first magnetic element is inserted;
wherein the second holder is designed as a second retaining collar projecting axially from the second base part to the first rotor and into which the at least one second magnetic element is inserted; and
wherein the turbine wheel is rotatably mounted on the turbine housing.

16. A turbine wheel arrangement according to claim 12, wherein the gap width is no more than 1 mm.

17. A turbine wheel arrangement according to claim 6, wherein the first outer sleeve element and the second outer sleeve element are designed as identical parts.

18. A turbine wheel arrangement according to claim 7, wherein the first inner sleeve element and the second inner sleeve element are designed as identical parts.

19. A turbine wheel arrangement according to claim 6, wherein the first rotor and the second rotor are designed as identical parts and are detachably fixed to the turbine wheel by the first outer sleeve element and the second outer sleeve element, respectively.

20. A turbine wheel arrangement comprising:
a turbine wheel;
a magnetic coupling having a first rotor and a second rotor, each of which is rotationally movable about a common axis of rotation defining an axial direction;
a partition arranged in the axial direction between the first rotor and the second rotor, the partition running in a plane perpendicular to the axis of rotation; and
a plurality of pole rods arranged on the partition along a circumferential direction;
wherein the first rotor is connected to the turbine wheel in a rotationally fixed manner;
wherein the first rotor is magnetically coupled with the second rotor in the axial direction;
wherein at least one of:
the first rotor includes a first base part connected to the turbine wheel in a rotationally fixed manner, at least one first magnetic element, and a first holder on an end face of the first base part facing the second rotor and in which the at least one first magnetic element is retained; and
the second rotor includes a second base part, at least one second magnetic element, and a second holder on an end face of the second base part facing the first rotor and in which at least one second magnet element is retained;
wherein the first holder is designed as a first retaining collar projecting axially from the first base part to the second rotor and into which the at least one first magnetic element is inserted;
wherein the second holder is designed as a second retaining collar projecting axially from the second base part to the first rotor and into which the at least one second magnetic element is inserted.
